(19) United States
(12) Patent Application Publication
(10) Pub. No.: US 2016/0176124 A1
(43) Pub. Date: Jun. 23, 2016

(54) METHOD OF INJECTION MOLDING A PART MADE OF COMPOSITE MATERIAL WITH PRIOR PRE-CONSOLIDATION OF THE FIBER PREFORM

(71) Applicant: SAFRAN, Paris (FR)

(72) Inventors: Bastien TRANQUART, Arcueil (FR); Sebastien PAUTARD, Palaiseau (FR)

(73) Assignee: SAFRAN, Paris (FR)

(21) Appl. No.: 14/906,936

(22) PCT Filed: Jul. 21, 2014
(86) PCT No.: PCT/FR2014/051876

§ 371 Date: Jan. 22, 2016

(30) Foreign Application Priority Data
Jul. 22, 2013 (FR) 1357193

(51) Int. Cl. B29C 70/48; B29C 45/14; B29C 70/22; B29B 11/14

(52) U.S. Cl. CPC B29C 70/48; B29B 11/14; B29C 45/14; B29C 70/22; B29K 2105/20

(57) ABSTRACT

A method of injection molding a part made of composite material including fiber reinforcement densified by a matrix, the method including, in succession, placing a fiber preform in an injection mold, injecting a thermoplastic resin under pressure so as to impregnate the preform, and polymerizing the resin, the fiber preform being consolidated in the injection mold prior to injecting the resin.

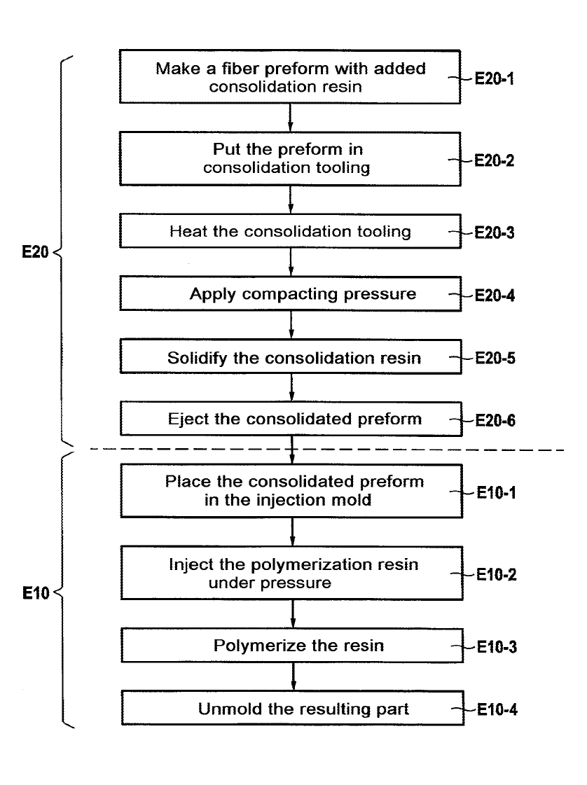

### BACKGROUND OF THE INVENTION

The present invention relates to the general field of fabricating parts made out of composite material comprising fiber reinforcement densified by a matrix.

More precisely, the invention relates to an injection molding method for making a composite material part, e.g. in the field of aviation.

In known manner, an injection molding method consists in placing a fiber preform in an injection mold, in injecting a liquid resin under pressure into the injection mold so as to impregnate the preform, in polymerizing the resin, and then in unmolding the part. When the composite material has an organic matrix, the resins used are generally thermosetting or thermoplastic resins.

With this type of method, it frequently happens that injecting resin under pressure into the injection mold leads to defects in the preform, in particular problems of positioning the yarns of the preform (some of the yarns of the preforms tend to move), and problems of loss of registration between laminations (i.e. deformation between two different plies).

Unfortunately, defects that appear in the fiber preform during the stage of injecting resin lead to local changes in the mechanical properties of the final part, and in particular to reductions in moduluses and to changes in the axes of the warp and weft yarns, and also to post-injection deformations.

Furthermore, when using thermoplastic resins, these defects are amplified by the high injection pressures that are necessary in order to take account of the high viscosity of such resins. Adding additives for limiting the viscosity of such resins is found not to be sufficient for mitigating such drawbacks.

### OBJECT AND SUMMARY OF THE INVENTION

A main object of the present invention is thus to propose an injection molding method that does not present the above-mentioned drawbacks.

This object is achieved by a method of injection molding a part made of composite material comprising fiber reinforcement densified by a matrix, the method comprising, in succession, placing a fiber preform in an injection mold, injecting a thermoplastic resin under pressure so as to impregnate the preform, and polymerizing the resin, wherein in accordance with the invention, the fiber preform is consolidated in the injection mold prior to injecting the resin.

Compared with prior injection molding methods, the invention provides a step that consists in consolidating the fiber preform prior to injecting the resin. This pre-consolidation of the fiber preform thus makes it possible to limit the effects of registration being lost in the preform while the polymerization resin is being injected. The uniformity of the mechanical properties of the resulting part is thus greatly improved.

Preferably, the method comprises a consolidation step of consolidating the fiber preform prior to injecting the resin into the injection mold, this consolidation step comprising: making a fiber preform within which a consolidation resin is present; placing the fiber preform in consolidation tooling; heating the consolidation tooling to the melting temperature of the consolidation resin present within the fiber preform; and solidifying the consolidation resin.

Making a fiber preform within which a consolidation resin is present may comprise inserting consolidation resin yarns while weaving the fiber preform.

Alternatively, making a fiber preform within which a consolidation resin is present may comprise dusting the fiber preform with a consolidation resin in powder form.

Also alternatively, making a fiber preform within which a consolidation resin is present may comprise making a fiber preform using yarns coated in consolidation resin.

Furthermore, the step of consolidating the fiber preform may further comprise applying compacting pressure to the fiber preform in the consolidation tooling. Applying such a compacting pressure enables the porosity within the preform to be limited and enables its positioning within the consolidation tooling and its final shaping to be optimized for obtaining shapes that are warped.

Also preferably, the consolidation resin is identical to the resin injected into the injection mold so as to optimize cohesive and adhesive aspects.

The step of consolidating the fiber preform is performed using consolidation tooling that corresponds to the injection mold. Under such circumstances, the time required to fabricate the composite material part is shortened since there is no need to transfer the consolidated preform.

### BRIEF DESCRIPTION OF THE DRAWING

Other characteristics and advantages of the present invention appear from the following description made with reference to the sole accompanying FIGURE, which shows an implementation having no limiting character.

### DETAILED DESCRIPTION OF THE INVENTION

The invention relates to making parts out of composite material comprising fiber reinforcement densified by a matrix. The invention applies more particularly to making parts that are used in the field of aviation (e.g. fan blades or guide vanes) by a liquid resin injection molding method in which the resin is a thermoplastic resin.

In conventional manner, the liquid resin injection molding method consists in injecting a liquid resin under pressure into an injection mold in which a fiber preform of the part that is to be fabricated has previously been placed. The thermoplastic resin is polymerized during a cycle of cooling the preform while the temperature of the tooling is regulated. Once the resin has polymerized, the part is unmolded.

The pressure at which the liquid resin is injected into the injection mold varies, in particular as a function of the nature of the resin. Typically, for an aviation part, the pressure lies in the range 500 bars to 2400 bars for a thermoplastic resin (by way of indication, the pressure generally lies in the range 10 bars to 30 bars for a thermosetting resin).

The fiber preform may be obtained in various ways that are known to the person skilled in the art. The preform may in particular be obtained directly by three-dimensional (3D), two-dimensional (2D), or 2.5D weaving of yarns (e.g. made of carbon fibers), or by draping or stacking sequences of two-dimensional fiber fabrics.

The nature of the resin depends in particular on the nature of the yarns used for forming the fiber preform. For a preform made out of carbon or glass yarns, it is possible to use a thermoplastic resin, e.g. a resin made from polyphenylene polysulfide and/or polyetherimide and/or polyetherketone, or a mixture of these components. Furthermore, the resin may optionally be filled, e.g. using short or long fibers, flakes, beads, mineral fillers, nanofillers, etc.

In accordance with the invention, prior to the molding process proper (E10), the injection molding method of the invention includes consolidation of the fiber preform (E20).

More precisely, and as shown in the FIGURE, consolidating the fiber preform prior to placing it in the injection mold consists initially in making a fiber preform within which a consolidation resin is present (step E20-1).

The consolidation resin is a thermoplastic resin that is preferably identical to the resin that is injected into the injection mold during the molding process proper. The consolidation resin is used directly for making the fiber preform using various techniques.

When it is of thermoplastic nature, the consolidation resin may be different from the resin that is injected into the injection mold. Specifically, certain polymers have chemical compatibility that is sufficient for the cohesive/adhesive aspect.

In one of these techniques, consolidation resin yarns are inserted directly in the fiber preform while it is being woven. For this purpose, consolidation resin yarns are used during the weaving to replace some of the yarns of the fiber preform. Preferably, the yarns used are of the same kind as the injected resin.

In another technique, consolidation resin prepared in the form of a powder is dusted directly onto the fiber preform once it has been made.

In yet another technique, the fiber preform is made using yarns that are coated in consolidation resin (i.e. yarns subjected to sizing).

Once a fiber preform has been obtained that has consolidation resin present inside it, the preform is placed in consolidation tooling (step E20-2).

The consolidation tooling may be compression or stamping tooling, an injection-compression mold, or indeed the same injection mold as is used during the molding process proper.

In particular, the consolidation tooling may be made in the same injection mold as that which is used during the molding process with a (heated) movable core or in a rotary mold having a plurality of stages (first stage for consolidation with a dedicated core/recess, second stage of opening and moving the mold in rotation and/or translation, and third stage of closing the mold with a new cavity to enable resin to be injected onto the preform that has been pre-consolidated in this way).

The consolidation tooling is then heated (step E20-3) until it reaches a temperature higher than the glass transition temperature of the consolidation resin.

If necessary, compacting pressure may be added while heating the consolidation tooling (step E20-4), in particular in order to limit porosity within the consolidated fiber preform and in order to optimize the positioning and the shaping of the preform within the consolidation tooling.

It is then possible to trigger solidifying the consolidation resin (step E20-5). This solidification is obtained during the cycle of cooling the consolidation tooling to a given optimum temperature.

After this step of solidifying the consolidation resin, the fiber preform is ejected from the consolidation tooling (step E20-6). The resulting preform is consolidated by the consolidation resin that was present inside the preform and that has polymerized therein.

At this stage, the consolidated fiber preform is rigid and can be handled easily. In particular, the fiber preform is sufficiently rigid to ensure that injecting resin under pressure during molding proper does not lead to the preform being deformed.

The process of molding proper can then begin (step E10). For this purpose, and as mentioned above, the consolidated fiber preform is placed in the injection mold (step E10-1). Naturally, this step, and also the step E20-6 of injecting the preform from the consolidation tooling, are not necessary if the consolidation tooling used is the injection mold.

Once the injection mold has been closed, liquid resin is injected under pressure into its inside (step E20-2) so that it becomes polymerized therein (by cooling—step E10-3). The resulting part is then unmolded (step E10-4) and possibly machined to have the desired final shape.

It should be observed that the pre-consolidated fiber preform may itself constitute a finished part and the process of injection proper may then serve to add specific functions thereto (by injecting and overmolding onto the part, elements such as fastening clips, tubes for screw fastening, metal tips, positioning ribs, etc.).

1. A method of injection molding a part made of composite material comprising fiber reinforcement densified by a matrix, the method comprising, in succession, placing a fiber preform in an injection mold, injecting a thermoplastic resin under pressure so as to impregnate the preform, and polymerizing the resin, wherein the fiber preform is consolidated in the injection mold prior to injecting the resin.

2. A method according to claim 1, including consolidating the fiber preform prior to injecting the resin into the injection mold, said consolidating comprising:
making a fiber preform within which a consolidation resin is present;
placing the fiber preform in the injection mold;
heating the injection mold to the melting temperature of the consolidation resin present within the fiber preform; and
solidifying the consolidation resin.

3. A method according to claim 2, wherein making a fiber preform within which a consolidation resin is present comprises inserting consolidation resin yarns while weaving the fiber preform.

4. A method according to claim 2, wherein making a fiber preform within which a consolidation resin is present comprises dusting the fiber preform with a consolidation resin in powder form.

5. A method according to claim 2, wherein making a fiber preform within which a consolidation resin is present comprises making a fiber preform using yarns coated in consolidation resin.

6. A method according to claim 2, wherein said consolidating the fiber preform further comprises applying compacting pressure to the fiber preform in the injection mold.

7. A method according to claim 2, wherein the consolidation resin is identical to the resin injected into the injection mold.
